(19) United States
(12) Patent Application Publication
(10) Pub. No.: US 2019/0235149 A1
(43) Pub. Date: Aug. 1, 2019

(54) LIGHT GUIDE PLATE AND LIQUID CRYSTAL MODULE

(71) Applicant: Wuhan China Star Optoelectronics Technology Co., Ltd., Wuhan, Hubei (CN)

(72) Inventor: Pengbo Xu, Wuhan, Hubei (CN)

(21) Appl. No.: 15/327,216

(22) PCT Filed: Dec. 27, 2016
(86) PCT No.: PCT/CN2016/112424

§ 371 Date: Apr. 20, 2018

(30) Foreign Application Priority Data
Dec. 23, 2016 (CN) 201611214463.3

(51) Int. Cl. F21V 8/00

(52) U.S. Cl. CPC G02B 6/0018; G02B 6/009

(57) ABSTRACT

Disclosed is a light guide plate, which relates to the technical field of a liquid crystal display panel. The light guide plate includes a light-emitting surface, a bottom surface, and a light-incoming end surface parallel to the light-emitting surface. The light guide plate further includes a first guide slope, a first end of which intersects the bottom surface and a second end of which intersects the light-incoming end surface. A first angle of greater than 90 degrees is formed between the first guide slope and the bottom surface. In particular, when the first angle is equal to 135 degrees, a total reflection prism is formed on the first guide slope, so that light perpendicular to the light-incoming end surface enters and travels in the light guide plate after a total reflection when the light passes by the first guide slope. A liquid crystal module including the light guide plate is further provided, thereby a lightness and thinness design of the liquid crystal module is realized.

### CROSS-REFERENCE TO RELATED APPLICATIONS

This application claims the priority of Chinese patent application CN 201611214463.3, entitled “Light Guide Plate and Liquid Crystal Module” and filed on Dec. 23, 2016, the entirety of which is incorporated herein by reference.

### FIELD OF THE INVENTION

The present disclosure relates to the technical field of a liquid crystal display panel, and in particular, to a light guide plate and a liquid crystal module. Since the liquid crystal module of the present disclosure includes the light guide plate of the present disclosure, a thickness of the liquid crystal module is made thinner.

### BACKGROUND OF THE INVENTION

Liquid crystal display devices are different from cathode ray tube (CRT), plasma display panel (PDP) and so on which are self-luminous. Because a liquid crystal itself does not emit light, an external light source is indispensable for display. A light source located at a back of a display screen is called a backlight. According to a positional relationship between a light source (i.e., fluorescent light, light-emitting diode, electroluminescence etc.) and a light guide plate, backlights can be divided into under-set backlights and side-set backlights. The under-set backlights have advantages of high light utilization and easiness to achieve large area lighting, and have disadvantages of non-uniform brightness and large thickness. As demands for portable devices, such as notebook computers, increase, there is an urgent need for a thinner and more light-weight liquid crystal module, and thus the side-set backlights are increasingly applied.

A thickness of a liquid crystal module is reduced to a certain extent by an application of a side-set backlight, but a thickness of an entire module is determined by a final stack of materials. FIG. 1 schematically shows a structure of an ultrathin module 10 in the prior art, in which a side-set backlight is used. A backlight 13 includes an LED light 131 and a fixation frame 132, and is provided on a left side of a light guide plate 12. A reflecting plate 11 is provided under the light guide plate 12. An interlayer 14 is provided over the light guide plate 12. A bonding layer 141 and a liquid crystal panel 15 are provided over the interlayer 14 in sequence. In order to prevent an influence of a backlight on a liquid crystal panel during a vibration, a slight first gap 16 is reserved between the liquid crystal panel 15 and the bonding layer 141. In order to accommodate the side-set backlight, the light guide plate 12 is provided with a first slope 121. Accordingly, when the liquid crystal panel 15 is disposed over the interlayer 14, there is a second gap 17 which cannot be compensated between the liquid crystal panel 15 and the bonding layer 141 over a light-emitting side 122 of the light guide plate. Therefore, a thickness of the module 10 is determined mainly by the reflecting plate 11, the light guide plate 12, the interlayer 14, the second gap 17, and the liquid crystal panel 15. In FIG. 1, a liquid crystal module mainly has a first thickness T1 of the light-emitting side of the light guide plate, a second thickness T2 of a light-incoming side of the light guide plate, and a thickness T3 of the entire liquid crystal module. When thicknesses of materials of the light-emitting side 122 of the light guide plate, the reflecting plate 11 and so on are reduced to a certain extent, it is hard to further reduce a thickness of the liquid crystal module due to a limitation of great difficulty in reducing thicknesses of materials of an LED, a flexible printed circuit board and so on. A 5.2″ ultrathin liquid crystal module in the prior is taken as an example. A first thickness T1 of the 5.2″ ultrathin liquid crystal module is 0.52 mm, and a second thickness T2 thereof is 0.63 mm. A thickness T3 of the entire 5.2″ ultrathin liquid crystal module is 0.97 mm with a second gap of 0.06 mm. The second gap cannot be eliminated due to a limitation of existing materials. Therefore, in order to further reduce the thickness of the liquid crystal module, i.e., to eliminate the second gap, a new technique is required.

### SUMMARY OF THE INVENTION

In order to further reduce a thickness of a liquid crystal module, the present disclosure provides a light guide plate, and at the same time, provides a backlight module including the light guide plate. By means of the backlight module including the light guide plate, a second gap in the prior art is eliminated, so that a thickness of the backlight module is smaller.

The light guide plate provided by the present disclosure comprises a light-emitting surface, a bottom surface disposed opposite to the light-emitting surface, and a light-incoming end surface disposed parallel to the light-emitting surface. The light-incoming end surface comprises a first edge and a second edge. The first edge is adjacent to the light-emitting surface, and the second edge is far from the light-emitting surface. The light guide plate further comprises a first guide slope. A first end of the first guide slope intersects the bottom surface at a first boundary, and a second end of the first guide slope is connected to the second edge of the light-incoming end surface. The first guide slope and the bottom surface form a first angle of greater than 90 degrees therebetween.

For the light guide plate provided by the present disclosure, after light enters the light guide plate through the light-incoming end surface, the light is directly emitted onto the first guide slope. Then, after being reflected on the first guide slope, the light travels in the light guide plate.

As a further improvement to the present disclosure, the light guide plate further comprises a second guide slope. A first end of the second guide slope intersects the light-emitting surface at a second boundary, and a second end of the second guide slope is connected to the first edge of the light-incoming end surface. The second guide slope and the light-emitting surface form a second angle of greater than 90 degrees therebetween.

After such an arrangement, thicknesses of respective parts of the light guide plate can be substantially uniform, and thus less material is needed. Besides, it is conductive to an integral molding and is convenient for manufacture of the light guide plate.

As an improvement to the light guide plate having the first guide slope and the second guide slope, the light guide plate further comprises a first side disposed perpendicular to the light-incoming end surface, and the first guide slope is connected to the second edge of the light-incoming end surface via the first side. The light guide plate further comprises a second side disposed parallel to the first side, and the second guide slope is connected to the first edge of the light-incoming end surface via the second side.

After the first side and the second side are arranged, a thickness of the light guide plate is increased so that the light-incoming end surface and a liquid crystal panel are in a substantially same level. Thus, a distance between a light source on a flexible printed circuit board and the light-incoming end surface is shortened, and a light leakage is reduced, so that an existing light source can be more fully used.

In a preferred embodiment, the first angle is not less than the second angle. In particular, when the first angle is equal to the second angle and is 135 degrees, a right-angle prism is formed on the first guide slope. According to a principle of the right-angle prism, it can be known that light emitted through the light-incoming end surface is emitted at an angle of 45 degrees with respect to the first guide slope, and the light emitted through the light-incoming end surface is reflected totally by the first guide slope, after being emitted on the first guide slope, into the light guide plate. Thus, the light leakage is further reduced, and a utilization rate of a light source is improved.

In one embodiment of the present disclosure, the light-incoming end surface coincides with the light-emitting surface, and the first angle is equal to 135 degrees.

Such a light guide plate is formed by using a part of an end portion of a light surface as a light-incoming end surface and forming a chamfer of 45 degrees at a bottom surface opposite to the light-incoming end surface. Therefore, such a light guide plate is easier to manufacture. Moreover, when the first angle is equal to 135 degrees, a right-angle prism is formed on the first guide slope likewise. According to the principle of the right-angle prism, it is known that the light emitted through the light-incoming end surface is emitted at an angle of 45 degrees with respect to the first guide slope, and the light emitted through the light-incoming end surface is reflected totally by the first guide slope, after being emitted onto the first guide slope, into the light guide plate. Thus, the light leakage is further reduced, and the utilization rate of the light source is improved. Besides, since the light guide plate no longer has the first side and the second side, it can be made directly from a flat plate. Thus, a structure of the light guide plate is stronger, and the cost thereof is lower.

The present disclosure provides a liquid crystal module comprising the light guide plate provided by the present disclosure. The liquid crystal module is provided with a reflecting plate, a light guide plate, an interlayer, and a liquid crystal panel in sequence. A light source is provided on the light-incoming end surface of the light guide plate, and the light source is provided on a flexible printed circuit board of the liquid crystal panel.

Instead of using a side-set light source, with a fixation frame, provided under a liquid crystal panel in the prior art, the light guide plate provided by the present disclosure is used in the liquid crystal module, and an LED light source is provided on the flexible printed circuit board of the liquid crystal with the flexible printed circuit board and the liquid crystal panel being disposed at a same height. Thus, a thickness of the liquid crystal module is further reduced, which is conductive to a lightness and thinness design of the liquid crystal module.

### BRIEF DESCRIPTION OF THE DRAWINGS

The present disclosure will be described in a more detailed way below based on embodiments and with reference to the accompanying drawings. In the drawings:

FIG. 1 schematically shows a structure of a 5.2″ ultrathin liquid crystal module 10 in the prior art;

FIG. 2 schematically shows a structure of a light guide plate in a first embodiment of the present disclosure;

FIG. 3 schematically shows a structure of a light guide plate in a second embodiment of the present disclosure;

FIG. 4 schematically shows a structure of a light guide plate in a third embodiment of the present disclosure;

FIG. 5 schematically shows a structure of a light guide plate in a fourth embodiment of the present disclosure;

FIG. 6 schematically shows a structure of a liquid crystal module 20 of the present disclosure; and

FIG. 7 schematically shows a structure of a liquid crystal module 30 of the present disclosure.

In the accompanying drawings, same reference signs are used for same components. The accompanying drawings are not drawn according to actual proportions.

### DETAILED DESCRIPTION OF THE EMBODIMENTS

The present disclosure will be further described below in combination with the accompanying drawings.

### Embodiment 1

FIG. 2 shows a light guide plate 100 in a first embodiment of the present disclosure. A cross section of the light guide 100 is as shown in FIG. 2. As can be seen in FIG. 2, the light guide plate 100 comprises a light-emitting surface 101 and a bottom surface 102. The bottom surface 102 and the light-emitting surface 101 are oppositely disposed. In the present embodiment, there is a slope at a left end of the bottom surface 102, which forms a first guide slope 104. A first end of the first guide slope 104 intersects the bottom surface 102 at a first boundary 111 where a first angle θ1 is formed by the first guide slope 104 and the bottom surface 102. Preferably, the first angle θ1 is greater than 90 degrees.

A first auxiliary 112′ perpendicular to the bottom surface is formed upwards starting from the first boundary 111. The first auxiliary 112′ intersects the light-emitting surface 101 at a first edge 112. On the light-emitting surface 101, a light-incoming end surface 103 is formed from the first edge 112 leftwards to a left edge of the light-emitting surface 101, and a left edge of the light-incoming end surface 103 is called a second edge 113. That is, an area between the first edge 112 and the second edge 113 is the light-incoming end surface 103. The first guide slope 104 intersects the light-incoming end surface 103 at the second edge 113. An entity of the light guide plate 100 can be obtained by an extension of the cross section as shown in FIG. 2 in a direction vertical to the cross section.

When an incident light 20 perpendicular to the light-incoming end surface 103 enters the light guide plate 100, the incident light 20 is directly emitted on the first guide slope 104 and then is reflected by the first guide slope 104 into the light guide plate. In implementation, bumps are provided on the first guide slope 104 so that more light emitted onto the first guide slope 104 is reflected into the light guide plate, thus a light leakage caused by refraction is reduced. In particular, when the first angle θ1 is 135 degrees, a total reflection prism is formed on the first guide slope 104 so that the light emitted on the first guide slope 104 is totally reflected into the light guide plate without any refraction. Thus, an existing light source is more fully used, and brightness of a liquid crystal panel is improved.

### Embodiment 2

FIG. 3 shows a light guide plate 200 in a second embodiment of the present disclosure. A cross section of the light guide 200 is shown in FIG. 3. As can be seen in FIG. 3, the light guide plate 200 comprises a light-emitting surface 201, a bottom surface 202 disposed opposite to the light-emitting surface 201, and a light-incoming end surface 203 disposed parallel to light-emitting surface 201. In the present embodiment, a first end of a first guide slope 204 intersects the bottom surface 202 at a first boundary 211, and a second end of the first guide slope 204 intersects the light-incoming end surface 203 at a second edge 213. The first guide slope 204 and the bottom surface 202 form a first angle θ2 therebetween at the first boundary 211.

In contrast to the Embodiment 1, the light guide plate 200 further includes a second guide slope 205. A first end of the second guide slope 205 intersects the light-emitting surface 201 at a second boundary 214, and a second end of the light-emitting surface 205 intersects the light-incoming end surface 203 at a first edge 212. The second guide slope 205 and the light-emitting surface 201 form a second angle θ2 therebetween at the second boundary 214. Preferably, 32 is greater than 90 degrees, and the first angle θ2 is not less than the second angle θ2. In this way, a certain width of the light-incoming end surface 203 can be ensured, and manufacture of the light guide plate 200 can be facilitated. An entity of the light guide plate 200 can be obtained by an extension of the cross section as shown in FIG. 3 in a direction vertical to the cross section.

When an incident light 20 perpendicular to the light-incoming end surface 203 enters the light guide plate 200, the incident light 20 is directly emitted onto the first guide slope 204 and then enters the light guide plate after being reflected by the first guide slope 204. In implementation, a portion of light reflected by the first guide slope 204 is emitted onto the second guide slope 205 and then is reflected by the second guide slope 205. In order to prevent a light leakage caused by refraction at the first guide slope 204 and the second guide slope 205, bumps are provided on the first guide slope 204 and the second guide slope 205, so that more light emitted on the first guide slope 204 and the second guide slope 205 can be reflected into the light guide plate, thereby reducing the light leakage caused by refraction. In particular, when the first angle θ2 and the second angle θ2 are both 135 degrees, a total reflection prism is formed respectively on the first guide slope 204 and the second guide slope 205, such that the light emitted on the first guide slope 204 is reflected into the light guide plate totally without any refraction. Besides, a portion of light is repeatedly reflected by the first guide slope 204 and the second guide slope 205, and finally travels in the light guide plate, thereby reducing the light leakage. Thus, an existing light resource is more fully used, and display brightness of a liquid crystal panel is improved.

### Embodiment 3

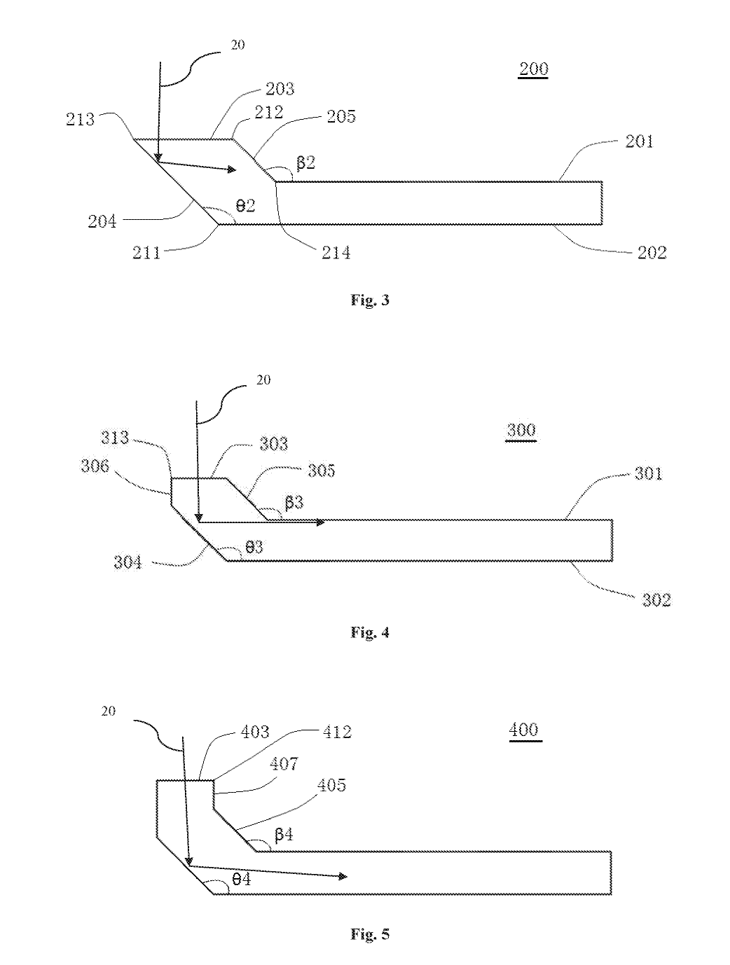

FIG. 4 shows a light guide plate 30X) in a third embodiment of the present disclosure. A cross section of the light guide plate 300 is shown in FIG. 4. As can be seen in FIG. 4, the light guide plate 300 comprises a light-emitting surface 301, a bottom surface 302, a first guide slope 304, a second guide slope 305, and a light-incoming end surface 303. In contrast to the light guide plate 200 in the Embodiment 2, the light guide plate 300 further comprises a first side 306 which is perpendicular to the light-incoming end surface 303. A first end of the first side 306 intersects the light-incoming end surface 303 at a second edge 313, and a second end of the first side 306 intersects the first guide slope 304, i.e., the first guide slope 304 is connected to the second edge 313 of the light-incoming end surface 303 via the first side 306. In the present embodiment, a first angle θ3 and a second angle θ3 are both greater than 90 degrees, and the first angle θ3 is not smaller than the second angle 33. By means of an arrangement of the first side 306, a height of the light-incoming end surface 303 is increased to a certain extent, and a distance between a light source on a flexible printed circuit board and the light-incoming end surface is shortened. Thus, the light source can be used more efficiently. An entity of the light guide plate 300 can be obtained by an extension of the cross section as shown in FIG. 4 in a direction vertical to the cross section.

For the light guide plate 300 in the present embodiment, when an incident light 20 perpendicular to the light-incoming end surface 303 enters the light guide plate 300, the incident light 20 is directly emitted onto the first guide slope 304 and then enters the light guide plate after being reflected by the first guide slope 304. In implementation, a portion of light reflected by the first guide slope 304 is emitted onto the second guide slope 305 and then is reflected by the second guide slope 305. In order to prevent a light leakage caused by refraction at the first guide slope 304 and the second guide slope 305, bumps are provided on the first guide slope 304 and the second guide slope 305, so that more light emitted on the first guide slope 304 and the second guide slope 305 can be reflected into the light guide plate, thereby reducing the light leakage caused by refraction. In particular, when the first angle θ3 and the second angle θ3 are both 135 degrees, a total reflection prism is formed respectively on the first guide slope 304 and the second guide slope 305, such that the light emitted onto the first guide slope 304 is reflected into the light guide plate totally without any refraction. Moreover, a portion of light is repeatedly reflected by the first guide slope 304 and the second guide slope 305, and finally travels in the light guide plate, thereby reducing the light leakage. Thus, an existing light resource is more fully used, and display brightness of a liquid crystal panel is improved.

### Embodiment 4

FIG. 5 shows a light guide plate 400 in a fourth embodiment of the present disclosure. A cross section of the light guide plate 400 is shown in FIG. 5. As can be seen in FIG. 5, in contrast to the light guide plate 300, the light guide plate 400) further comprises a second side 407 which is perpendicular to a light-incoming end surface 403. A first end of second side 407 intersects the light-incoming end surface 403 at a first edge 412, and a second end of the second side 407 intersects the second guide slope 405, i.e., the second guide slope 405 is connected to the first edge 412 of the light-incoming end surface 403 via the second side 407.

In contrast to the light guide plate 300, a height of the light-incoming end surface 403 in the light guide plate 40) is further increased to a certain extent, and a distance between a light source on a flexible printed circuit board and the light-incoming end surface is further shortened. Thus, the light source can be used more efficiently. An entity of the light guide plate 400 can be obtained by an extension of the cross section as shown in FIG. 5 in a direction vertical to the cross section.

For the light guide plate 400 in the present embodiment, when an incident light 20 perpendicular to the light-incoming end surface 403 enters the light guide plate 400, the incident light 20 is directly emitted onto the first guide slope 404 and then enters the light guide plate after being reflected by the first guide slope 404. In implementation, a portion of light reflected by the first guide slope 404 is emitted onto the second guide slope 405 and then is reflected by the second guide slope 405. In order to prevent a light leakage caused by refraction at the first guide slope 404 and the second guide slope 405, bumps are provided on the first guide slope 404 and the second guide slope 405, so that more light emitted on the first guide slope 404 and the second guide slope 405 can be reflected into the light guide plate, thereby reducing the light leakage caused by refraction. In particular, when a first angle θ4 and a second angle β4 are both 135 degrees, a total reflection prism is formed respectively on the first guide slope 404 and the second guide slope 405, such that the light emitted on the first guide slope 404 is reflected into the light guide plate totally without any refraction. Besides, a portion of light is repeatedly reflected by the first guide slope 404 and the second guide slope 405, and finally travels in the light guide plate, thereby reducing the light leakage. Thus, an existing light resource is more fully used, and display brightness of a liquid crystal panel is improved.

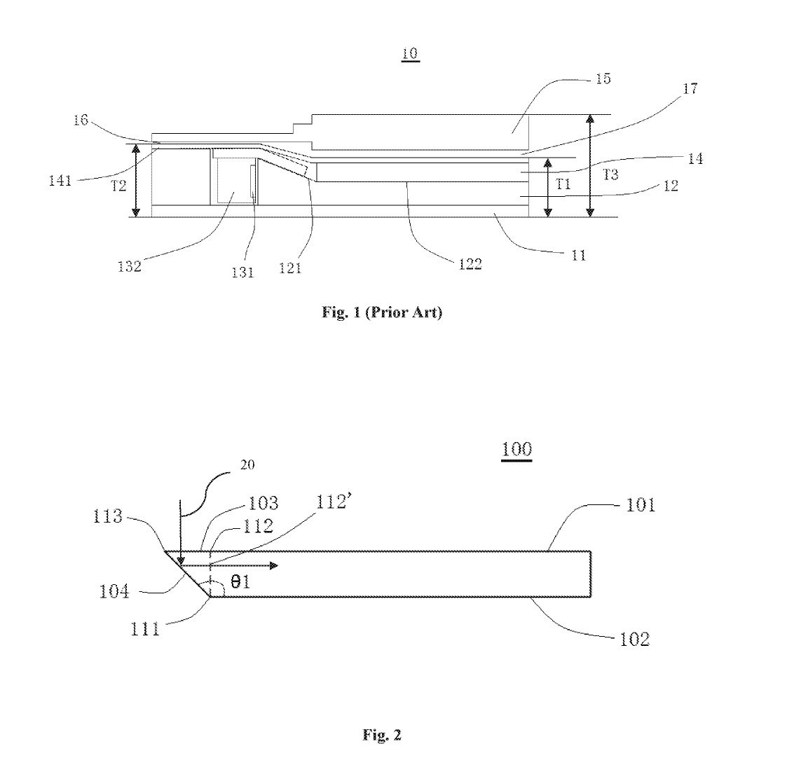

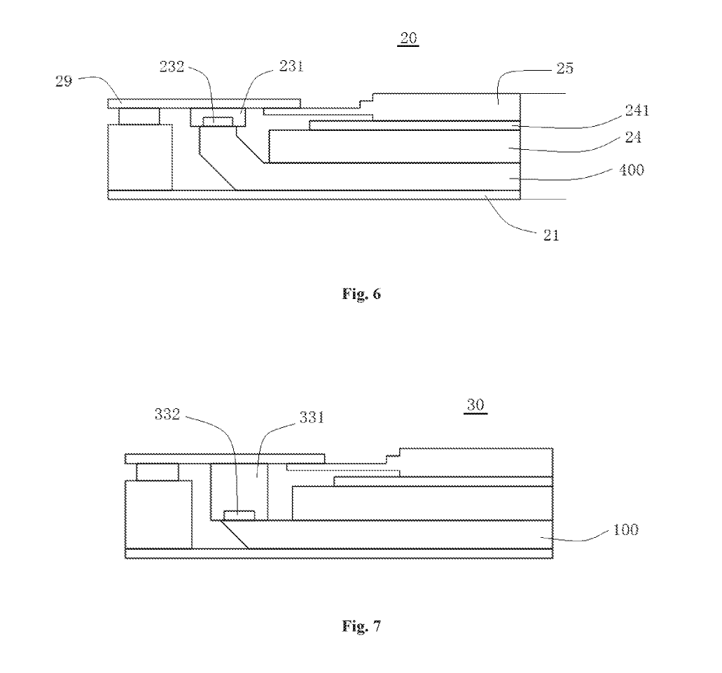

The present disclosure further provides a liquid crystal module, and FIG. 6 schematically shows a structure of a liquid crystal module 20. The liquid crystal module 20 is provided with a reflecting plate 21, a light guide plate 400, an interlayer 24, a bonding layer 241, and a liquid crystal panel 25 from bottom to top. An LED light source 232 is provided on the light-incoming end surface of the light guide plate 400. The LED light source 232 is disposed on a flexible printed circuit board 29 of the liquid crystal panel 25 by means of a fixation frame 231. Since the flexible printed circuit board 29 and the liquid crystal panel 25 are arranged substantially at a same level, unlike an arrangement in the prior art as shown in FIG. 1 that an LED light source is disposed under a liquid crystal panel, a second gap in the prior art is eliminated. In the case of a 5.2″ ultrathin liquid crystal module, when other materials are unchanged, since the light guide plate 400 and an LED light source provided on a flexible printed circuit board in the present disclosure are used, a second gap is eliminated, thereby reducing a thickness T3′ of an entire liquid crystal module 20 to 0.91 mm. Thus, the liquid crystal module becomes thinner, and a lightness and thinness design of the liquid crystal module is realized.

When a light guide plate in other embodiments of the present disclosure is used in a liquid crystal module, a thickness of a fixation frame of an LED light source can be increased in a process of manufacturing the LED light source on a flexible printed circuit board. Thus, a height of the LED light source is increased in relation to the flexible printed circuit board, thereby compensating a distance between a light-incoming end surface of the light guide plate and an LED light-emitting surface. FIG. 7 schematically shows a structure of a liquid crystal module 30 in which the light guide plate 100 of the present disclosure is used. A height of an LED light source 332 fixed on a flexible printed circuit board is increased by means of a fixation frame 331, which compensates a distance between a light-incoming end surface of the light guide plate 100 and a LED light-emitting surface, so that the light source is more fully used. Thus, the liquid module becomes thinner, and it is beneficial for achieving the lightness and thinness design of the liquid crystal module.

It should be noted that the above embodiments are described only for better understanding, rather than restricting the present disclosure. Although the present disclosure is described in a detailed way with reference to preferable embodiments, it should be understood that any person skilled in the art can make amendments and equivalent substitutes to the technical solutions of the present disclosure without departing from the spirit and scope of the present disclosure, and the amendments and substitutes shall be covered within the scope as defined in the claims of the present disclosure.

1. A light guide plate, wherein the light guide plate comprises:
a light-emitting surface;
a bottom surface disposed opposite to the light-emitting surface;
a light-incoming end surface disposed parallel to the light-emitting surface and comprising a first edge adjacent to the light-emitting surface and a second edge far from the light-emitting surface; and
a first guide slope, wherein a first end of the first guide slope intersects the bottom surface at a first boundary, and a second end of the first guide slope is connected to the second edge of the light-incoming end surface, the first guide slope and the bottom surface forming a first angle of greater than 90 degrees therebetween.

2. The light guide plate according to claim 1, wherein the light guide plate further comprises a second guide slope, wherein a first end of the second guide slope intersects the light-emitting surface at a second boundary, and a second end of the second guide slope is connected to the first edge of the light-incoming end surface, the second guide slope and the light-emitting surface forming a second angle of greater than 90 degrees therebetween.

3. The light guide plate according to claim 2, wherein the light guide plate further comprises a first side, wherein the first side is perpendicular to the light-incoming end surface, and the first guide slope is connected to the second edge of the light-incoming end surface via the first side.

4. The light guide plate according to claim 3, wherein the light guide plate further comprises a second side, wherein the second side is parallel to the first side, and the second guide slope is connected to the first edge of the light-incoming end surface via the second side.

5. The light guide plate according to claim 2, wherein the first angle is not less than the second angle.

6. The light guide plate according to claim 5, wherein the first angle is equal to 135 degrees.

7. The light guide plate according to claim 1, wherein the light-incoming end surface coincides with the light-emitting surface.

8. The light guide plate according to claim 7, wherein the first angle is equal to 135 degrees.

9. The light guide plate according to claim 3, wherein the first angle is not less than the second angle.

10. The light guide plate according to claim 4, wherein the first angle is not less than the second angle.

11. A liquid crystal module, wherein the liquid crystal module is provided with a reflecting plate, a light guide plate, an interlayer, a bonding layer, and a liquid crystal panel from bottom to top, wherein a light source is provided on the light-incoming end surface of the light guide plate, and the light guide plate comprises:
a light-emitting surface;
a bottom surface disposed opposite to the light-emitting surface;
a light-incoming end surface disposed parallel to the light-emitting surface and comprising a first edge adjacent to the light-emitting surface and a second edge far from the light-emitting surface;
a first guide slope, wherein a first end of the first guide slope intersects the bottom surface at a first boundary, and a second end of the first guide slope is connected to the second edge of the light-incoming end surface, the first guide slope and the bottom surface forming a first angle of greater than 90 degrees therebetween.

12. The liquid crystal module according to claim 11, wherein the light guide plate further comprises a second guide slope, wherein a first end of the second guide slope intersects the light-emitting surface at a second boundary, and a second end of the second guide slope is connected to the first edge of the light-incoming end surface, the second guide slope and the light-emitting surface forming a second angle of greater than 90 degrees therebetween.

13. The liquid crystal module according to claim 12, wherein the light guide plate further comprises a first side, wherein the light guide is perpendicular to the light-incoming end surface, and the first guide slope is connected to the second edge of the light-incoming end surface via the first side.

14. The liquid crystal module according to claim 13, wherein the light guide plate further comprises a second side, wherein the second side is parallel to the first side, and the second guide slope is connected to the first edge of the light-incoming to end surface via the second side.

15. The liquid crystal module according to claim 14, wherein the first angle is not less than the second angle.

16. The liquid crystal module according to claim 15, the first angle is equal to 135 degrees.

17. The liquid crystal module according to claim 11, the light-incoming end surface coincides with the light-emitting surface.

18. The liquid crystal module according to claim 17, wherein the first angle is equal to 135 degrees.

19. The liquid crystal module according to claim 11, wherein the light source is provided on a flexible printed circuit board of the liquid crystal panel.
